(19) United States
(12) Patent Application Publication
(10) Pub. No.: US 2009/0113475 A1
(43) Pub. Date: Apr. 30, 2009

(54) Systems and methods for integrating search capability in interactive video

(75) Inventor: Yi Li, Wellesley, MA (US)

Correspondence Address: Yi Li, 54 Oak Street, Wellesley, MA, 02482, US

(73) Assignee: Yi Li, Wellesley, MA (US)

(21) Appl. No.: 12/195,404

(22) Filed: Aug. 20, 2008

Related U.S. Application Data
(60) Provisional application No. 60/965,653, filed on Aug. 21, 2007.
(60) Provisional application No. 61/003,821, filed on Nov. 20, 2007.

(51) Int. Cl. G06F 3/00; G06F 7/06; G06F 17/30; G10L 21/00

(52) U.S. Cl. 725/39; 707/3; 704/270.1; 707/E17.108; 707/E17.028; 704/E15.001

(57) ABSTRACT

This invention is a system and method that enables video viewers to search for information about objects or events shown or mentioned in a video through a search engine. The system integrates search capability into interactive videos seamlessly. When viewers of such a video want to search for information about something they see on the screen, they can click on it to trigger a search request. Upon receiving a search request, the system will automatically use an appropriate search term to query a search engine. The search results will be displayed as an overlay on the screen or in a separate window. Targeted ads that are relevant to the search term are delivered and displayed alongside search results. The system also allows viewers to initiate a search using voice commands. Further, the system resolves ambiguity by allowing viewers to select one of multiple searchable items when necessary.

### CROSS-REFERENCE TO RELATED APPLICATIONS

This application claims the benefit of U.S. Provisional Patent Application No. 60/965,653, filed Aug. 21, 2007, entitled “Systems and methods for embedding search capability in interactive video”; and U.S. Provisional Patent Application No. 61/003,821, filed Nov. 20, 2007, entitled “System and method for placing keyword-based targeted ads in interactive video.” The entirety of each of said provisional patent applications is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention is directed towards interactive video systems with embedded search capability, and more particularly towards systems and methods that enable viewers of a video program to search for information about objects or events shown or mentioned in the video.

2. Description of Prior Art

With the introduction of advanced interactive video systems, viewers can not only watch video programs, but also interact with them. For example, viewers can purchase products shown on the screen or retrieve and view the statistics of an athlete using a remote control. However, when viewers want to find more information about something they see in a video program, there is not a fast and natural way for them to search for the information they are looking for without interrupting their video viewing experience. They either have to stop watching the video program and conduct a regular online search using a computer: going to the web site of a search engine, entering a search term, and receiving a list of search results, or they need to conduct such an online search after watching the video program. More over, oftentimes viewers may not be able to formulate an appropriate search term that accurately or adequately describes the object of interest, so they can not find what they are looking for through online search. For example, if a viewer wants to search for information about the character “Christopher Moltisanti”, who is Tony Soprano's nephew, in the HBO drama The Sopranos, he needs to use the character's full name as the search term in order to get relevant information. However, a viewer who is not very familiar with the character may only know his first name “Christopher” because his full name is rarely used in the show. But using the first name to query a search engine won't get highly relevant information.

With its explosive growth in recent years, online video has become an important platform for advertisers to market their products or services. But, unlike the keyword-based ads displayed alongside search results on online search engines, which have proven to be an effective form of advertising, none of the existing types of ads in online video are very effective. In banner ads, a banner, which may be a picture of a product, a logo of a brand, or simply a text banner, is displayed at the corner of the screen during video playback. In pre-roll ads, viewers are forced to watch a short 10 or 15 second ad before they see the selected video. Both banner ads and pre-roll ads, like the traditional 30 second commercial breaks in TV programs, are not effective since most viewers find them annoying and ignore them. To engage viewers, advertisers begin to introduce interactive ads in video. In interactive overlay ads, for example, a clickable banner or short animation is displayed at the bottom of the screen from time to time during video playback. Viewers can click on the banner or the animation to view a longer version of the ad, or to be directed to a web site, so they can learn more about the advertised product or service. In contextual ads, advertisers try to match ads with the content of video. In a pre-processing step, scenes containing keywords or key-objects are extracted from the video using speech recognition and image analysis software. When the video is playing, ads that are relevant to those keywords or key-objects are displayed at the appropriate time. Both interactive overlay ads and contextual ads can irritate viewers since they don't take viewers' interests and intentions into consideration. Also, a complex and expensive ad-serving system needs to be built to serve these types of ads. But most video content publishers or distributors do not have the technical expertise and financial resources to build a high performance ad-serving system.

Accordingly, there is a need for interactive video systems with built-in search capability, which allows viewers to search for information about objects or events shown or mentioned in a video program in a natural and accurate way, so that viewers can find the information they need easily and quickly. There is also a need for systems and methods for dynamically placing highly effective ads in video that match viewers' interests and intentions in a non-intrusive manner.

### BRIEF SUMMARY OF THE INVENTION

The present invention integrates search capability into interactive video systems, enabling viewers to search for information about objects or events shown or mentioned in a video program. Highly targeted ads based on search terms used by viewers to conduct their searches are displayed alongside search results. These ads, like the keyword-based ads displayed on online search engines, are not irritating because they are only displayed when viewers are searching for information. They are highly effective because they closely match the interests or intentions revealed by viewers' searches. The present invention essentially enables viewers to decide what advertisements they see in a video and when to see them. Also, it utilizes built-in ad-serving systems of popular online search engines, eliminating the need for video content creators and distributors to build complex and expensive ad-serving systems themselves. It should be pointed out that the present invention can not only be applied to online video (including various types of IPTV services) but also be applied to digital cable TV systems.

In a video authoring process, a set of objects and/or events in a video program are defined as searchable items. A set of search terms, one of which being the default, are associated with each searchable item. While watching the video program, a viewer can select a searchable item to initiate a search using a number of methods and input devices. The interactive video system will identify the selected searchable item and use either a default search term or a search term selected or specified by the viewer to query a search engine. Search results along with targeted ads based on the search term will be displayed in a separate window or as overlay over the video frame. Other search terms associated with the selected searchable item will be displayed as search suggestions to allow the viewer to refine her search.

The present invention employs several methods for a viewer to select a searchable item and for the interactive video system to identify the selected searchable item, which include a location-based method, a timeline-based method, a snapshot-based method, and a speech recognition based method. Each of these methods can be used alone, or they can be used in conjunction with each other to give viewers more options for searchable item selection.

In the location-based method, searchable objects' locations in every frame of the video are tracked and stored as a set of corresponding regions in a sequence of object mask images. To select an object, a viewer clicks on the object with a point and click device such as a mouse. The interactive video system will identify the selected object based on location of the viewer's click.

In the timeline-based method, the time periods during which each searchable item appears on the screen are tracked and converted to frame counts, which are stored in a database. To select a searchable item, a viewer uses a point and click device to click on the screen. The interactive video system will identify the selected searchable item based on when the click takes place, or equivalently, which frame is clicked on.

In the snapshot-based method, a picture of a searchable item is displayed in the bottom corner of the screen. Clicking on the picture will initiate a search on the corresponding searchable item. A viewer can quickly browse through pictures of all the searchable items by pressing a button on the mouse or the remote control, like a slide show. Instead of having to wait for a searchable item to appear on the screen to make a selection, the viewer can select any searchable item at any time during the video.

In the speech recognition based method, speech recognition is used to enable viewers to select searchable items using voice commands. During the video authoring process, a set of synonyms are associated with each searchable item. To select a searchable item, a viewer simply says the name of the item. If the viewer's voice input can be recognized by the speech recognition engine as one of the synonyms for a particular searchable item, that object will be identified as the selected item.

### BRIEF DESCRIPTION OF THE SEVERAL VIEWS OF THE DRAWING

The present invention is illustrated by way of example, and not by way of limitation, in the figures of the accompanying drawings and in which like reference numerals refer to similar elements and in which:

FIG. 1 is a system diagram illustrating key components of the present invention for an illustrative embodiment;

FIG. 2 is a flow chart illustrating the sequence of actions in a typical usage scenario of the present invention;

FIGS. 3A-B illustrate a set of example screen views for the illustrative embodiment of the present invention, showing the results of a search about a character in a TV show;

FIG. 4 illustrates another example screen view for the illustrative embodiment of the present invention, showing the results of a search about a travel destination in a TV show;

FIG. 5 illustrates another example screen view for the illustrative embodiment of the present invention, showing a snapshot window at the bottom left corner of the screen;

FIG. 6 shows another example screen view for the illustrative embodiment, illustrating how ambiguity is resolved in the present invention;

FIG. 7 illustrates another example screen view for the illustrative embodiment, showing a search bar and a virtual on-screen keyboard that allow viewers to enter their own search terms; and

FIGS. 8A-B illustrate another set of example screen views for the illustrative embodiment of the present invention, showing the results of a search about a character in a TV show.

### DETAILED DESCRIPTION OF THE INVENTION

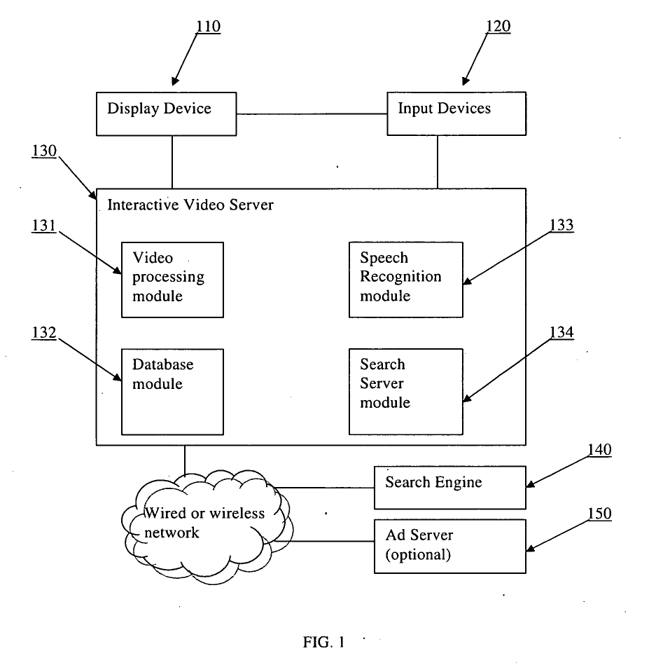

Refer first to FIG. 1, which illustrates key components of an illustrative embodiment of the present invention. The system consists of a Display Device 110, one or more Input Devices 120, and an Interactive Video Server 130, which is connected to a Search Engine 140 and an optional Ad Server 150 through a wired or wireless network.

The Display Device 110 can be a TV set, a computer monitor, a touch-sensitive screen, or any other display or monitoring system. The Input Device 120 may be a mouse, a remote control, a physical keyboard (or a virtual on screen keyboard), a microphone (used in conjunction with a speech recognition engine to process viewers' voice commands), or an integral part of a display device such as a touch-sensitive screen. The Interactive Video Server 130 may be a computer, a digital set-top box, a digital video recorder (DVR), or any other devices that can process interactive video. The Search Engine 140 may be a generic search engine, such as Google, or a specialized search engine that searches a retailer's inventory or a publisher's catalog. It may also be a combination of multiple search engines. The Ad Server 150 is optional. It is not needed if the Search Engine 140 has a built-in ad-serving system like Google's AdWords. Otherwise, the Ad Server 150, which should be similar in functionality to Google's AdWords, is required. Further, the above components may be combined into one or more physical devices. For example, the Display Device 110, the Input Device 120 and the Interactive Video Server 130 may be combined into a single device, such as a media center PC, advanced digital TV, or a cell phone.

The Interactive Video Server 130 may comprises several modules, including a Video Processing module 131 (used for video coding/decoding and graphics rendering), a Database module 132 (used to store various information of searchable items), a Speech Recognition module 133 (used to recognize viewers' voice input), and a Search Server module 134 (used to query the Search Engine 140 and process returned search results). The Video Processing module 131 is a standard component in a typical PC, set-top box or DVR. The Database module 132 is a combination of several types of databases, which may include SQL tables, plain text tables, and image databases. The Speech Recognition module 133 can be built using commercial speech recognition software such as IBM ViaVoice or open source software such as the Sphinx Speech Recognition Engine developed by Carnegie Mellon University.

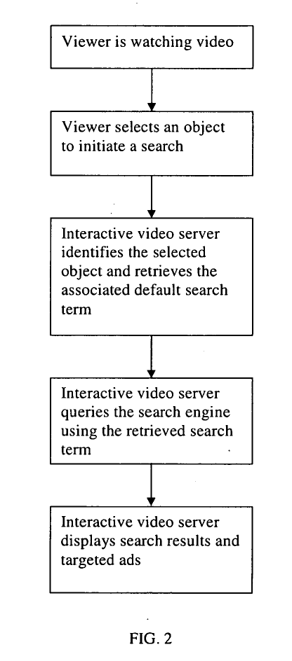

In a typical usage scenario, when a viewer wants to know more information about an object shown on the screen, she can select that object to initiate a search using the Input Device 120. For example, she can click on the object using a mouse. This will trigger a sequence of actions. First, the Interactive Video Server 130 will identify the clicked object, and retrieve a default search term associated with the identified object from a database. Then, it will query the Search Engine 140 using the retrieved search term. And finally, it will display the results returned by the Search Engine 140 either as an overlay or in a split window. Targeted ads will be served either by the built-in ad serving system of the Search Engine 140 or by the Ad Server 150. The viewer can choose to go over the results and ads immediately or save them for later viewing. The sequence of actions described above is illustrated in FIG. 2.

The ensuing discussion describes the various features and components of the present invention in greater detail.

1. Defining Searchable Items

In order to enable viewers to conduct a search by selecting a searchable item while watching a video, a set of searchable items that might be of interest to viewers need to be defined in an authoring process, either by an editor or, in certain situations, by viewers themselves, before the video is being watched. There are no restrictions on what types of items can be made searchable. A searchable item can be a physical object such as an actor or a product, or a non-physical item such as a geographical location or an event. (Examples of searchable events include natural events such as a snowstorm, sports events such as the Super Bowl, or political events such as a presidential election.) A searchable item can also be something not shown, but mentioned in the video program, such as a recipe mentioned in a cooking show, or a song being played in the video.

The process of defining a searchable item involves extracting certain information about the item from the video program and storing the extracted information in a database in the Database module 132 in FIG. 1. The present invention employs several methods for viewers to select a searchable item and for the interactive video system to identify the selected searchable item, which include a location-based method, a timeline-based method, a snapshot-based method, and a speech recognition based method. These methods require different types of information to be extracted, which are described below.

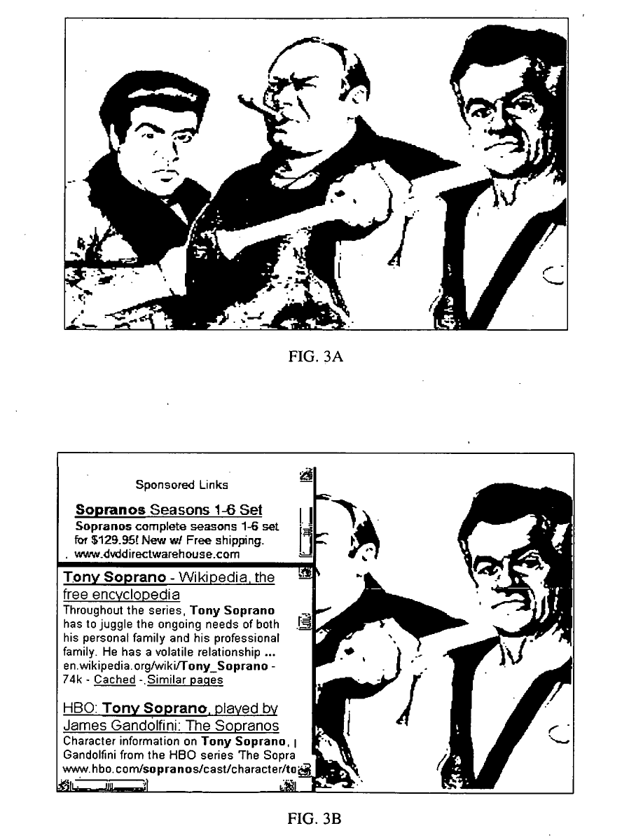

In the location-based method, a searchable item's location, in terms of corresponding pixels in a frame, is tracked throughout the video. In each frame, all the pixels belonging to the item are grouped and labeled as one region, which is stored in a frame of an object mask database in the Database module 132. (The object mask database is an image sequence that contains the same number of frames and has the same frame size as the video program being processed.) After the authoring process, each frame in the object mask database contains a set of regions corresponding to the searchable items appearing in the same frame of the video. When a viewer clicks on any pixel within a region, the corresponding item will be identified as the item selected by the viewer. Creating object mask database is a tedious and time-consuming process. Image and video processing technologies developed in recent years have made this process easier and faster; see Bove, et al., “Adding Hyperlinks to Digital Television”, Proc. 140th SMPTE Technical Conference, 1998. FIG. 3A shows an example frame of the HBO drama “The Sopranos”, in which the character “Tony Soprano” (the man in the middle) is defined as a searchable object during the authoring process described above. When a viewer clicks on the character, the Interactive Video Server 130 will use the default search term “Tony Soprano” to query the Search Engine 140. FIG. 3B illustrates an example screen view according to an embodiment of the present invention, showing the search results and targeted ads which are displayed as an overlay on the video screen. The search results and targeted ads (in the form of sponsored links) shown in this example and the subsequent examples are all returned by Google. The images in these figures and the subsequent figures are for exemplary purposes only, and no claim is made to any rights for the images displayed and for the television shows mentioned. All trademark, trade name, publicity rights and copyrights for the exemplary images and television shows are the property of their respective owners.

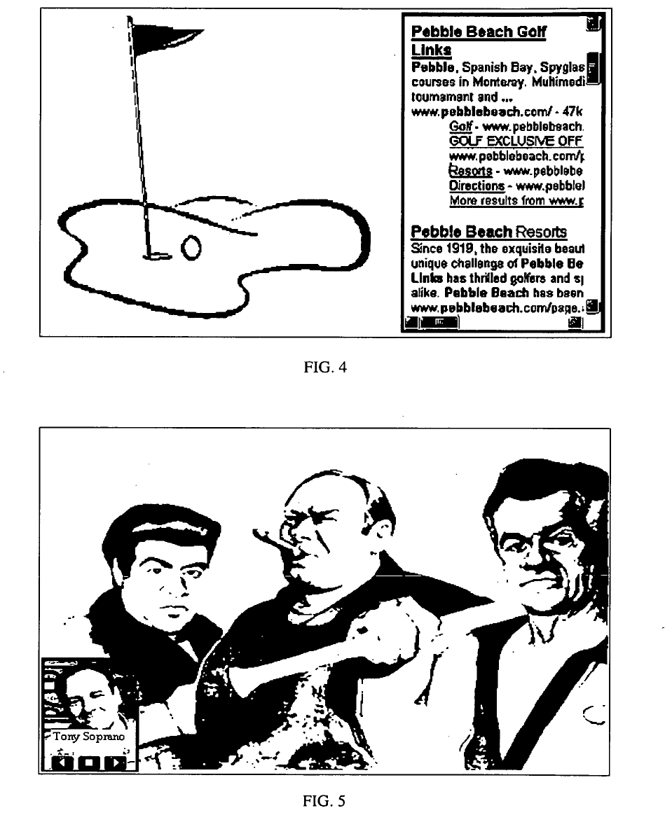

In many video programs, the number of items that might be of interest to viewers is limited, and it is unlikely that two or more such items appear in the same frame. In these situations, a timeline-based method can be used, where a timeline for each searchable item is established in the authoring process to indicate the time periods during which a searchable item appears on the screen. Time periods can be easily converted to frame counts based on frame rate (a typical frame rate for video is 30 frames per second). For example, if a searchable item appears on the screen for the first 60 seconds of the video, its frame count would be frame 1 to frame 1800 (30×60). So in the present invention, a timeline actually indicates in which frames its corresponding searchable item is shown, and is stored in a database in the Database module 132 in the form of a binary array with N elements, where N is the number of frames in the video. Each element in the array corresponds to a frame in the video. It equals to 1 if the searchable item appears in the frame, and equals to 0 otherwise. Oftentimes viewers want to search for information about something that is not a physical object or doesn't correspond to a region on the screen. For example, a viewer may want to search for related stories about a news event in a news show, or she may want to search for information about a travel destination mentioned in a travel show. In these situations, timelines can also be established for the events or non-physical objects, so that they can be defined as searchable items. FIG. 4 is a frame from a TV show featuring famous golf resorts, in which Pebble Beach Golf Links is mentioned and is defined as a searchable item using the timeline-based method. While watching the show, a viewer can click on the frame to trigger a search about Pebble Beach Golf Links. The screen view shows the search results along with the targeted ads using the default search term “pebble beach golf links”. Similarly, a viewer can also search for more information about a recipe mentioned in a cooking show, or search for more information about a piece of music played in a video.

In videos where searchable items are small or they move fast on screen, or the scene changes rapidly, it is difficult to track and click on searchable items with a point and click device. Once a searchable item disappears from the screen, viewers can no longer clicks on it. To address these problems, the present invention uses a snapshot-based method to make any searchable items available for viewers to select at any time during video playback. In the authoring process, a snapshot for each searchable item is collected and is stored in an image database in the Database module 132. An item's snapshot can be a picture of that item or a representative video frame containing that item. During video playback, a snapshot along with its corresponding searchable item's search terms are displayed in a small window overlaid on the bottom corner of the screen or in a separate window. A viewer can quickly browse through all the snapshots one by one by pressing a button on the remote control or the mouse, just like watching a slide show. Clicking on a snapshot will trigger a search about the corresponding searchable item. FIG. 5 is a frame from the HBO drama “The Sopranos”, in which the character “Tony Soprano” (the man in the middle) is defined as a searchable item. The screen view shows a window containing the snapshot of “Tony Soprano” along with its search term at the bottom left corner of the video screen.

The speech recognition based method is another alternative for searchable item selection and identification employed by the present invention. Recent advances in speech recognition have made small vocabulary, speaker independent recognition of words and phrases very reliable. So it becomes feasible to integrate speech recognition engines into interactive video systems to enhance viewers' video viewing experience; see Li, “VoiceLink: A Speech Interface for Responsive Media”, M.S. thesis, Massachusetts Institute of Technology, September 2002. In the present invention, during the authoring process, each searchable item is associated with a set of words or phrases that best describe the searchable item. These words or phrases, which are collectively called synonyms, are stored in a database in the Database module 132. It is necessary to associate multiple synonyms to a searchable item because different viewers may call the same item differently. For example, the searchable item in FIG. 3A, which is the character “Tony Soprano”, is associated with four synonyms: “Tony Soprano”, “Tony”, “Soprano”, and “James Gandolfini” (which is the name of the actor who plays “Tony Soprano”). When a viewer speaks a word or phrase, if the speech recognition engine can recognize the viewer's speech input as a synonym of a particular searchable item, that item will be identified as the selected searchable item.

2. Associating Search Terms with Searchable Items

In the authoring process, once searchable items are defined, a set of search terms are associated with each searchable item, and are stored in a database in the Database module 132. Since viewers may search for information about different aspects of a searchable item, multiple search terms can be assigned to a single searchable item, in which case one of them is set as the default search term for that item. For example, the searchable item in FIG. 3A, which is the character “Tony Soprano”, is associated with two search terms: “Tony Soprano” and “James Gandolfini”, where “Tony Soprano” is set as the default search term. When viewers select a searchable item, the default search term will be used to query the Search Engine 140 automatically. The other search terms will be displayed as search suggestions, either automatically or upon viewers' request, to allow viewers to refine their search. A search bar can also be displayed to allow viewers to enter their own search terms. The Interactive Video Server 130 keeps track of what searchable items viewers select, what search terms viewers use for each searchable item, and what new search terms viewers enter. Over time, the initial set of search terms created in the authoring process will be augmented by viewer-entered search terms, and the most frequently used search term for a given searchable item can be set as the default searchable term, replacing the initial default. Some of the synonyms for speech recognition can also be used as search terms.

3. Object Selection and Identification

The present invention allows viewers to select a searchable item to initiate a search while watching a video program using two types of input devices: (1) Point and click devices, such as a mouse, a remote control, or a touch sensitive screen; (With additional hardware and software, the viewer can also select an object to search using a laser pointer.) (2) Speech input device, such as a microphone. As mentioned earlier, the present invention employs several methods for searchable item selection and identification. Each of these methods can be used alone, or they can be used in conjunction with each other to give viewers more options for searchable item selection.

In the location-based method, a viewer selects a searchable item by clicking on it using a mouse or a remote control, or using a finger if the video program is being viewed on a touch sensitive screen. The Interactive Video Server 130 in FIG. 1 will first determine which frame and which pixel within that frame is being clicked on. Then it will retrieve the corresponding frame from the object mask image database and identify the region that contains the pixel being click on. Finally, this region's corresponding searchable item will be identified as the selected searchable item. In an implementation variation of the present invention, when the viewer moves the cursor of the mouse into a searchable item's region, the Interactive Video Server 130 will highlight the item and display its search terms in a small window to indicate that the item is searchable. The viewer can initiate a search by either clicking on the highlighted item or clicking on one of its displayed search terms.

In the timeline-based method, a viewer simply clicks on the screen to select a searchable item shown on the screen. The Interactive Video Server 130 will first determine which frame is being clicked on. Then it will search the timeline database to look for the searchable item appearing in the clicked-on frame. If such a searchable item is found, it will be identified as the selected searchable item.

In the snapshot-based method, instead of having to wait for a searchable item to appear on the screen in order to make a selection, a viewer can select any searchable item at any time while watching a video. The viewer can quickly browse through the snapshots of all the searchable items by pressing a button on a mouse or a remote control. To select a searchable item, she just needs to click on the corresponding snapshot. The Interactive Video Server 130 will identify the searchable item that corresponds to the clicked-on snapshot as the selected item.

In an implementation variation of the present invention, the timeline-based method can be used in conjunction with the snapshot-based method to enable the snapshot window to display the snapshot and search terms of the searchable item currently shown on the screen. In this case, the snapshot window serves as an indicator to alert viewers when a searchable item appears on the screen.

In the speech recognition based method, a viewer can also select any searchable items at any time while watching a video. Instead of clicking on a searchable item using a mouse or remote control, the viewer can speak the name or a typical synonym of the searchable item to initiate a search. The microphone will capture the viewer's speech and feed the speech input to the Speech Recognition module 133 in FIG. 1. If the viewer's speech can be recognized as a synonym of a particular searchable item, that item will be identified as the selected searchable item.

In an implementation variation of the present invention, the snapshot-based method can be used in conjunction with the speech recognition based method to show viewers what items are searchable. In this case, the snapshot window slowly cycles through every searchable item's snapshot along with its search terms. To initiate a search about a searchable item, the viewer simply speaks one of its search terms displayed in the snapshot window.

4. Resolving Ambiguity

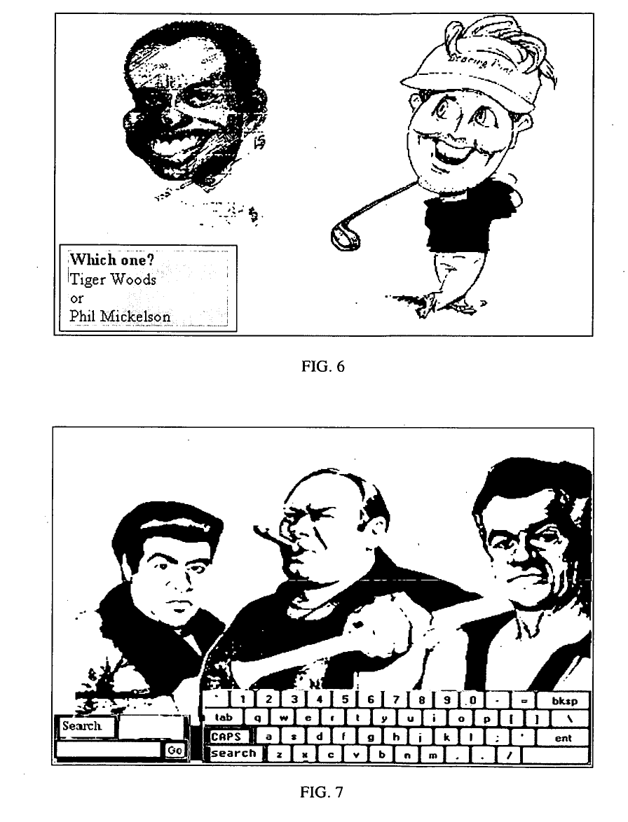

In the timeline-based method, ambiguity arises when a viewer clicks on a frame that contains two or more searchable items, because the Interactive Video Server 130 can't tell which item the viewer intends to select. To resolve the ambiguity, the Interactive Video Server 130 simply displays the default search terms of all the ambiguous searchable items, and prompts the viewer to specify the intended one by clicking on its default search term. For example, FIG. 6 shows a frame from a TV show featuring famous golfers, in which two golfers “Tiger Woods” (the man on the left) and “Phil Mickelson” (the man on the right) are defined as searchable items. When the viewer clicks on this frame, the Interactive Video Server 130 can't determine which golfer the viewer wants to select, so it lists both golfers' names, which are their default search terms, in the bottom left corner of the screen. The viewer can click on one of the names to initiate a search.

Similarly, in the speech recognition based method, ambiguity arises when the viewer speaks a word or phrase that is a synonym for two or more searchable items. The Interactive Video Server 130 resolves ambiguity by listing the ambiguous searchable items' distinct synonyms on the screen, and prompting the viewer to choose the intended item by speaking its corresponding synonym.

In an implementation variation, instead of displaying the default search terms or synonyms of the ambiguous searchable items, the Interactive Video Server 130 displays their snapshots. The viewer can choose the intended searchable item by clicking on its corresponding snapshot. This makes it easier for viewers to differentiate ambiguous searchable items.

5. Query Search Engines and Display Search Results

Once the searchable item selected by the viewer is identified, The Search Server module 134 in FIG. 1 will use its default search term or the search term selected by the viewer to query the Search Engine 140. The search term being used will be displayed in a status bar superimposed on the screen, indicating that the system is conducting the requested search. In addition to a set of search results, a number of targeted ads based on the search term will also be returned by the built-in ad-serving system of the Search Engine 140 and/or by the optional Ad Server 150. Search results and targeted ads can be displayed in a number of ways. They can be displayed in a separate window, or in a small window superimposed on the video screen, or as a translucent overlay on the video screen. Viewers can choose to navigate the search results and ads immediately, or save them for later viewing. As mentioned earlier, this form of ads will not irritate viewers because they are only displayed when viewers are searching for information. They are highly effective because they closely match viewers' interests or intentions. Oftentimes, the ads themselves are the information viewers are searching for. If the selected searchable object is associated with multiple search terms, the additional search terms will be listed as search suggestions to allow the viewer to refine her search. The viewer can click on one of the suggestions to initiate another search.

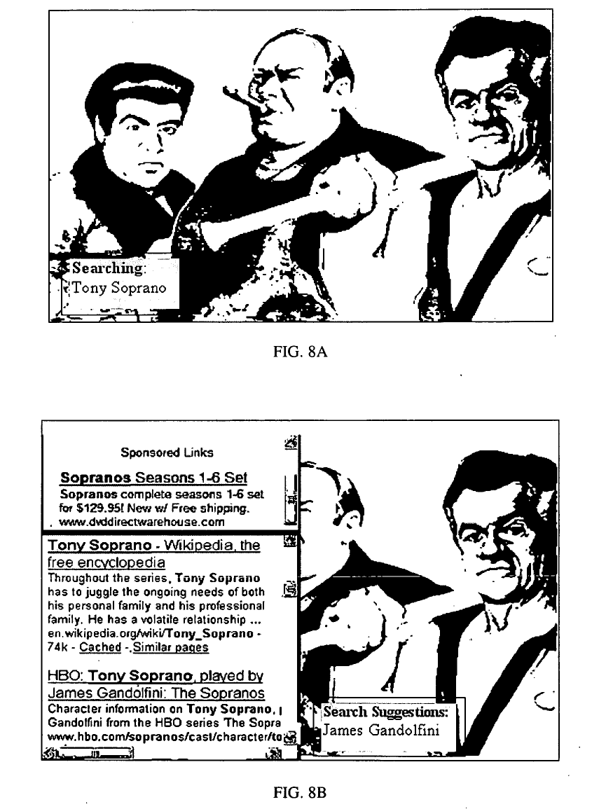

FIG. 8A shows a frame from the HBO drama “The Sopranos”, in which the character “Tony Soprano” (the man in the middle) is defined as a searchable item. It is associated with two search terms: “Tony Soprano” and “James Gandolfini”, where “Tony Soprano” is set as the default search term. When the viewer clicks on the character “Tony Soprano”, the Interactive Video Server 130 will query the search engine using the default search term “Tony Soprano”, which is displayed in the status bar at the bottom left corner of the screen. The corresponding search results and targeted ads along with search suggestions are displayed in separate windows overlaid on the screen, shown in FIG. 8B.

A search bar can also be integrated into the system to allow the viewer to enter a search term using a keyboard or a built-in virtual on-screen keyboard. FIG. 7 illustrates such an example screen view, showing a search bar and a virtual on-screen keyboard.

In a generic search engine like Google, multiple content types, such as web, image, video, news, maps, or products, can be searched. In one implementation, the Search Server module 134 searches multiple content types automatically and assembles the best results from each of the content types. In an implementation variation, when defining searchable items in the authoring process, the defined searchable items are classified into different types, such as news-related, location-related, and product-related. The Search Server module 134 will search a specific content type in Google based on the type of the selected searchable item. For example, if the viewer selects to search for more information about a news event in a news show, Google news will be queried; if the viewer selects to search for more information about a restaurant mentioned in a video, Google map will be queried. The Search Server module 134 can also query a specialized search engine based on the type of the selected searchable item. For example, if the viewer selects a book mentioned in a video, book retailer Barnes & Noble's online inventory can be queried.

While the present invention has been described with reference to particular details, various changes and substitutions are intended in the foregoing disclosures, and it will be appreciated that in some instances some features of the invention will be employed without a corresponding use of other features without departing from the scope and spirit of the invention. Therefore, many modifications may be made to adapt a particular situation to the essential scope and spirit of the present invention. It is intended that the invention not be limited to the particular terms used in the descriptions and/or to the particular embodiment disclosed as the best mode contemplated for carrying out this invention, but that the invention will include any and all embodiments and equivalents falling within the scope of the invention.

What I claim as my invention is:

1. A method for integrating search capability in interactive video, the method comprising the steps of:
a. Defining searchable items in a video;
b. Associating, with each searchable item, at least one search term;
c. Requesting a search by selecting a searchable item during video viewing;
d. Identifying the selected searchable item; and
e. Querying at least one search engine using a search term associated with the identified searchable item, and displaying the returned search results.

2. The method of claim 1, wherein said defining searchable items is based on identifying, for each searchable item, its location in each video frame.

3. The method of claim 1, wherein said defining searchable items is based on identifying, for each searchable item, the video frames in which it appears.

4. The method of claim 1, wherein said defining searchable items is based on displaying, for each searchable item, its picture on the video screen.

5. The method of claim 1, wherein said defining searchable items is based on associating, with each searchable item, at least one word or phrase for speech recognition.

6. The method of claim 1 or claim 2, wherein said selecting a searchable item and said identifying the selected searchable item comprising the steps of:
a. Clicking on the video screen to select a searchable item;
b. Identifying the video frame and the location within said video frame that are being clicked on; and
c. Identifying the searchable item that appears in the identified video frame that is being clicked on and corresponds to the identified location that is being clicked on.

7. The method of claim 1 or claim 3, wherein said selecting a searchable item and said identifying the selected searchable item comprising the steps of:
a. Clicking on the video screen to select a searchable item;
b. Identifying the video frame that is being clicked on; and
c. Identifying the searchable item that appears in the identified video frame that is being clicked on.

8. The method of claim 1 or claim 4, wherein said selecting a searchable item and said identifying the selected searchable item comprising the steps of:
a. Clicking on the picture of a searchable item; and
b. Identifying the searchable item that corresponds to the clicked-on picture.

9. The method of claim 1 or claim 5, wherein said selecting a searchable item and said identifying the selected searchable item comprising the steps of:
a. Speaking a word or phrase that is associated with a searchable item;
b. Recognizing the word or phrase that is spoken using a speech recognition engine; and
c. Identifying the searchable item that is associated with the recognized word or phrase.

10. The method of claim 1, further comprising the step of: Generating and displaying a plurality of forms of targeted ads, based on the search term used to query the at least one search engine.

11. The method of claim 1, further comprising the step of: Displaying two or more searchable items' information, including their pictures and/or unique search terms, to resolve ambiguity in the step of identifying the selected searchable item.

12. The method of claim 1, wherein said defining searchable items further comprising the step of: Classifying each searchable item to at least one of a plurality of types.

13. The method of claim 1 or claim 12, wherein said querying at least one search engine further comprising the step of: Querying one of a plurality of types of search engines based on the type of the selected searchable item.

14. An interactive video system with embedded search capability, the system comprising:
a. A display device;
b. At least one input device;
c. An interactive video server; and
d. At lease one search engine.

15. The system of claim 14, wherein the interactive video server is connected with the at lease one search engine through a network.

16. The system of claim 14, wherein the interactive video server comprising:
a. A video processing module, used for video coding/decoding and graphics rendering;
b. A database module, used for storing said searchable items' information;
c. A search server module, used for querying the at lease one search engine and processing returned search results.

17. The system of claim 14, wherein the interactive video server further comprising: A speech recognition module, used for speech recognition.

18. The system of claim 14, further comprising: An ad server, used for generating search term based targeted ads, the ad server is connected with the interactive video server through a network.
